(19) United States
(12) Patent Application Publication
(10) Pub. No.: US 2005/0275933 A1
(43) Pub. Date: Dec. 15, 2005

(54) In-plane switching electrophoretic display devices

(75) Inventors: Mark Thomas Johnson, Eindhoven (NL); Alexander Victor Henzen, Heerlen (NL); Hugo Johan Cornelissen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: koninklijke Philips Electronics N. V., Groenewoudseweg (NL)

(21) Appl. No.: 10/520,875

(22) PCT Filed: Jun. 23, 2003
(86) PCT No.: PCT/IB03/02892

§ 371 Date: Jan. 11, 2005

(30) Foreign Application Priority Data
Jul. 17, 2002 (EP) 02077899.9

(51) Int. Cl. G02B 26/00

(52) U.S. Cl. 359/296

(57) ABSTRACT

This invention relates to an in-plan switching electrophoretic display device (IPS-EPD), comprising a layer of electrophoretic material (2), being sandwiched between a first and a second substrate (3, 4), a pixel of said display further comprising a first and a second electrode (5, 6) for locally controlling the material of said electrophoretic layer. The first and second electrodes (5, 6) are positioned on essentially the same distance from said first substrate, so that an essentially lateral field is generated in said electrophoretic layer (2) when a signal is applied over said electrodes (5, 6), in order to enable transflective operation. The display device may further comprise an optionally patterned reflector (8), and a light schielding layer (7).

This invention relates to an electrophoretic display device, comprising a layer of electrophoretic material, being sandwiched between a first and a second substrate, a pixel of said display further comprising a first and a second electrode for locally controlling the material of said electrophoretic layer.

An electrophoretic display essentially comprises a suspension of coloured particles in a liquid having another colour than the above particles. The particles are arranged to move under the influence of an applied electric field. By moving the particles in a direction perpendicular to the viewing surface of the display, the display may be given the colour of the particles, and by moving the particles away from the viewing surface, the display takes the colour of the liquid.

However, since electrophoretic displays typically have the above construction, i.e. are based on absorbing and/or reflecting particles moving in a liquid between electrodes, being arranged on a front and a back substrate, respectively, it has some disadvantages when it comes to certain display types. For example, this construction has several shortcomings where transmissive operation is concerned. Since the particles always are in the light path, transmissive operation is more or less impossible.

Some efforts have been made to achieve a transflective electrophoretic display. One example is described in the patent application document U.S. 2001/0009352. This document discloses an electrophoretic display being formed by a rather advanced structure of plasma channels and fibre electrodes. However, a more simple device, being able to be driven in transflective operation, is desired. Moreover, when driven in transmissive mode, light generated by a backlight must propagate through a stack of several material layer and surfaces before reaching a potential viewer, and thereby a display device, making better use of the back light is desired.

Hence, the object of the invention is to provide a display device, being able to be driven in a transflective mode. Another object is to achieve a display device having a simple structure. Yet another object of the invention is to achieve a display, having a high brightness.

These and other objects are at least partly achieved by a display device in accordance with the introduction further being characterised in that said first and second electrodes are positioned on essentially the same distance from said first substrate, so that an essentially lateral field is generated in said electrophoretic layer when a signal is applied over said electrodes, in order to enable transflective operation. By applying an essentially lateral field over the electrophoretic layer instead of the traditional field generated by two electrodes being arranged on opposite substrates, transflective operation may be achieved, since the lateral field may be used to move the particles in and out of the light path of the display. Preferably, said electrodes are arranged essentially parallel to each other.

Moreover, said electrodes are preferably arranged essentially on said first substrate, making the display easy to manufacture. Said first substrate is moreover suitably a transmissive front substrate. By arranging the electrodes on the front substrate, any particles may then be accumulated in front of the reflector, and thereby the field is essentially not influenced by the reflector.

According to an embodiment of this invention, the display device further comprises a light shield element for generating a reservoir part of said pixel, said light shield element being arranged between said first substrate and one of said electrodes. Thereby, one of the electrodes is not visible for a viewer of the display, and do not affect the transmission characteristics of the display.

The display may be driven in two states, a distributed state, in which the particles are distributed in a display cell in such a way that they essentially covers the cell area, and a collected state, in which the particles are collected in a chosen area of the cell, in order to affect the transmission of the cell in a small extent, if any.

Moreover, since one of the electrodes is positioned under the light shield, it may be used to control the particles so that essentially all particles are positioned under the light shield in the collected state, and thereby do not affect the transmission characteristics of the display in this state. Hence, a good transmission state may be achieved.

Preferably, a reflector element is arranged on one of said substrates, being a back substrate, in the area between said electrodes as seen from a viewer side of said display device. Moreover, said back substrate is suitably transmissive and said reflector is one of a semi-transmissive reflector or a patterned reflector, in order to allow transflective operation.

According to one embodiment of the invention, the patterned reflector is such that the pixel comprises a reflector area and a transmission area, each essentially extending between said first and second electrode. This enables simultaneous operation in the transmissive and reflective mode, respectively. Alternatively, the patterned reflector is such that the pixel comprises a reflector area and a transmission area, each being essentially parallel with said first and second electrode.

Said layer of electrophoretic material suitably consists of a suspension of one of absorbing or reflecting particles in a liquid. Preferably, absorbing particles are used. Moreover, according to one embodiment, said layer of electrophoretic material comprises two or more domains, containing particles having mutually different absorption spectra This enables the generation of a wavelength dependent display, i.e. a colour display. In still a further embodiment, said layer of electrophoretic material comprises at least one domain comprising two or more types of particles having mutually different absorption spectra, in order to generate a colour display with multi-coloured pixels. In this case, additional electrodes may be required to facilitate colour separation within the multicoloured pixels.

This invention will hereinafter be described in closer detail, by means of presently preferred embodiments of the invention, with reference to accompanying drawing.

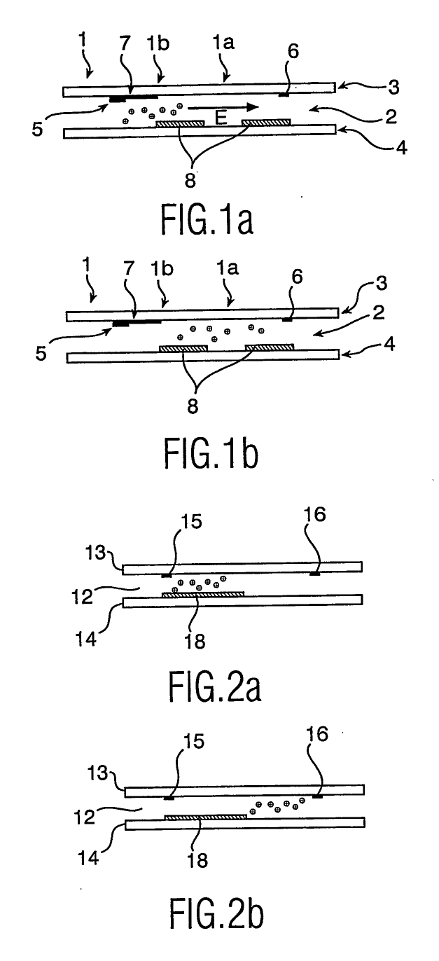

FIGS. 1a and 1b is a cross-section view of a display device according to a first embodiment of the invention, in a white state and a black state, respectively.

FIGS. 2a and 2b is a cross-section view of a display device according to a second embodiment of the invention, in two different states.

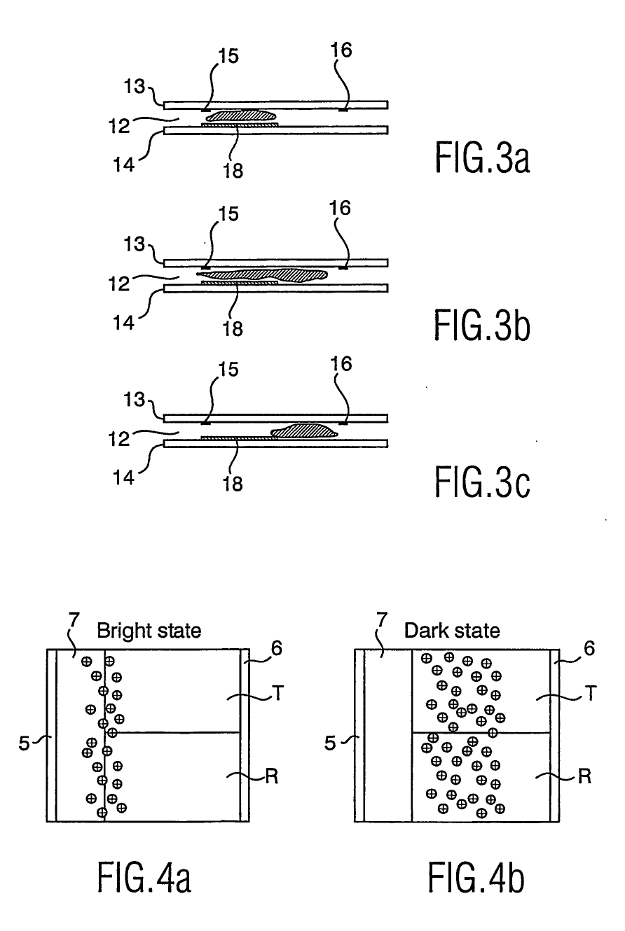

FIGS. 3a, 3b and 3c is a cross-section view of a display device according to a third embodiment of the invention in three different states.

FIGS. 4a and 4b discloses a fourth alternative embodiment of this invention in a bright and a dark state, as seen from a viewer side of a display device.

A first embodiment of this invention will hereinafter be described with reference to FIGS. 1a and 1b. FIGS. 1a and 1b discloses a cross section of a display element of a non-emissive display, here an electrophoretic display of reservoir type, comprising a transmission part 1a and a reservoir part 1b. The display element constitutes a pixel of said display. A display is built up by a plurality of such pixels, for example being driven by active matrix driving. The driven pixel element comprises a layer of electrophoretic material 2, such as a transparent, translucent or light coloured solution carrying dark coloured, charged and absorbing particles, said layer 2 being sandwiched between a front and a back substrate 3, 4. The above reservoir part 1b is arranged by providing an obstructing light shield element 7 on the front substrate, blocking transmission through this part of the pixel. In the pixel part, a reflecting element 8 is arranged on the opposite substrate, i.e. the back substrate 4. In order to provide a display device being able to be operated in both a reflective and transmissive mode, both the front and the back substrate 3, 4 shall be made of an essentially transparent material. In accordance with the invention, a first and a second electrode 5, 6 is arranged in the pixel. The electrodes are arranged on the same substrate, in this case the front substrate 3. The first electrode 5 is so arranged that said light shield 7 separates the first electrode 5 from the front substrate 3 itself, while the second electrode 6 essentially is arranged directly on the front substrate 3. In the present embodiment, the electrodes are comparatively thin and arranged in parallel along essentially the entire width of the pixel. Further, control means (not shown) are arranged to apply a control signal over said electrodes 5, 6 in order to generate an electric field in the electrophoretic layer 2. By means of said electric field, the positions of the particles in the layer 2 may be controlled in order to put the display in one of a bright state, as shown in FIG. 1a, and a black state, as shown in FIG. 1b. In the bright state (collected state) the field is so controlled that the particles of the electrophoretic layer 2 are drawn towards the first electrode, and hence towards the reservoir part 1b. In this state, the particles do not obstruct transmission of light through the transmission part 1a of the pixel, for example emanating from a backlight positioned beneath the display device, as seen from a potential viewer. In this case, the reflecting element 8 as well as the backlight are visible, and the overall display appearance is “white”. Hence, this is referred to as a bright or white state. In the black state (distributed state), the field is so controlled that the particles moves towards the second electrode 6 and becomes distributed over the transmission part 1a of the pixel and hence obstruct transmission of light through the transmission part 1a of the pixel as the particles essentially cover the transmissive part as well as the reflectors. When completely covered, the appearance of the display will be black. Moreover, by using absorbing particles in the layer 2, ambient light falling into the pixel from the surroundings will not be reflected by the pixel, and hence a good black state is achieved.

A second embodiment of this invention will hereinafter be described with reference to FIGS. 2a and 2b. FIGS. 2a and 2b discloses a cross section of a display element of a non-emissive display, here an electrophoretic display without a reservoir. The display element constitutes a pixel of said display. A display is built up by a plurality of such pixels. The pixel element comprises a layer of electrophoretic material 12, such as a transparent, translucent or light coloured solution carrying dark coloured, charged and absorbing particles, said layer 12 being sandwiched between a front and aback substrate 13, 14. In order to provide a display device being able to be operated in both a reflective and transmissive mode, both the front and the back substrate 13, 14 shall be made of an essentially tannsparent material. In accordance with the invention, a first and a second electrode 15, 16 is arranged in the pixel. The electrodes are arranged on the same substrate, in this case the front substrate 13. In the present embodiment, the electrodes are comparatively thin and arranged in parallel along essentially the entire width of the pixel. Moreover, a reflector 18 is arranged between said electrodes 15, 16, as seen from a viewer side of the display, said reflector 18 being arranged on the back substrate 14, in this case covering essentially half of the area between said electrodes. Further, control means (not shown) are arranged to apply a control signal over said electrodes 15, 16 in order to generate an electric field in the electrophoretic layer 12. By means of said electric field, the positions of the particles in the layer 12 may be controlled in order to put the display in one of a bright state, as shown in FIG. 2a, and a black state, as shown in FIG. 2b. In this case, since the particles cannot be stored in a reservoir, it is possible to move the particles by means of the applied electrical field into the area that is intended for reflective mode, when the display is to be driven in transmissive mode, and the other way around, and in that way generate a display that is switchable between a reflective and a transmissive mode. Thereby, as seen in FIG. 2a, the particles may be moved to the reflective part of the pixel, when the display is to be driven in a transmissive mode, and thereby not obstruct the transmission, while suppressing the reflection, and, as seen in FIG. 2b, the particles may be moved to the transmissive part of the pixel, when the display is to be driven in a reflective mode, and thereby not obstruct the reflection, while suppressing the transmission. This embodiment will result in a display which behaves inversely for both modes: If a pixel is intended to be black in the transmission mode, it will appear white in reflection mode. In this way, it is also possible to display grey tones, by partially moving the absorbing particles from one area to the other. This configuration has the advantage over the configuration of FIGS. 1a and 1b that it provides an even bigger aperture.

With the basic structure as disclosed in FIGS. 2a and 2b (i.e. without a reservoir), it is also possible to achieve a non-inverting display, as disclosed in FIG. 3a-3c. In this case, absorbing particles are present in the layer 2 in numbers way in excess of the required number to display a black pixel. Thereby, the excess of particles in the layer 2 may be used to keep the unused part of the pixel (transmissive or reflective) covered. In this way, the display will simply appear black in the opposite illumination mode. Switching between transmissive and reflective modes are done by applying, by means of said electrodes, a transition pulse, intended to move all particles from one side of the pixel to the other side. FIG. 3a discloses a state where essentially all particles are positioned in the reflective part of the pixel, and hence the transmission part is in a white state, and the reflection part is in a black state. FIG. 3b discloses a state in which the particles are distributed over the entire pixel, and hence both the reflection and transmission parts are in a black state. Finally, FIG. 3c discloses a state where essentially all particles are positioned in the reflective part of the pixel, and hence the transmission part is in a black state, and the reflection part is in a white state.

In all of the above described embodiments, the reflecting part as well as the transmitting part is arranged in parallel with the electrodes. However, the transmitting and reflecting parts may also be rotated with respect to the electrodes as well as the reservoir, if any. This is disclosed in FIGS. 4a and 4b. In this case, both the transmissive and reflective part essentially has an extension from the first to the second electrode, and the transmissive and reflective parts essentially has the same size. This configuration enables simultaneous operation in the transmissive and reflective mode. FIG. 4a discloses a bright state, in which essentially all particles of the electrophoretic layer 2 are collected under the reservoir light shield 7, and hence do not affect the transmission in the transmissive part of the pixel nor the reflection in the reflective part of the pixel. FIG. 4b discloses a dark state, in which the particles of the electrophoretic layer 2 are distributed over the reflective as well as the transmissive part of the display, and hence obstruct transmission in the transmissive part and hinders reflection in the reflective part.

According to an alternative embodiment, an extra pair of electrodes may be added to the embodiment disclosed in FIGS. 4a and 4b, namely one electrode above and one below the pixel (i.e. one on the front substrate side and one on the back substrate side). In this way the particles of the layer 2 may be directed to the transmissive or reflective part, which enables exclusive operation in the transmissive or reflective mode.

While the invention as been particularly shown and described with reference to specific embodiments thereof, it should be understood by those skilled in the art that various changes in form and detail may be made therein without departing from the spirit and scope of the invention as defined by the amended claims. One variant that may be made is to use a layer of electrophoretic material comprising two or more domains, containing particles having mutually different absorption spectra Thereby, a wavelength dependent display may be generated, i.e. a colour display. Moreover, different particles may be used, and as an example, reflecting particles may be used for certain applications. Moreover, several pixel layouts are possible, utilising the same inventive idea. For example, several types of particles having mutually different absorption spectra may be incorporated into the same domain, to generate a colour display with multi-coloured pixels. In this case, additional electrodes may be required to facilitate colour separation within the multi-coloured pixels.

Hence, this invention provides a display device capable of being operated in transflective mode, i.e. both front and back illumination is possible. As compared to a standard super twisted nematic display, the invention provides a display without performance differences between the transmissive and reflective mode, due to the fact that the optimisation for both the reflective and transmissive mode are essentially identical, and tests has shown that a monochrome display according to the invention is about two times as bright as a monochrome STN display, while a colour display according to the invention is about six times as bright as a corresponding colour STN display.

1. Electrophoretic display device, comprising a layer of electrophoretic material, being sandwiched between a first and a second substrate, a pixel of said display further comprising a first and a second electrode for locally controlling the material of said electrophoretic layer, characterized in that said first and second electrodes are positioned on essentially the same distance from said first substrate, so that an essentially lateral field is generated in said electrophoretic layer when a signal is applied over said electrodes, in order to enable transflective operation.

2. Display device according to claim 1, wherein said electrodes are arranged essentially parallel to each other.

3. Display device according to claim 1, wherein said electrodes are arranged essentially on said first substrate.

4. Display device according to claim 3, wherein said first substrate is a transmissive front substrate.

5. Display device according to claim 3, further comprising a light shield element for generating a reservoir part of said pixel, said light shield element being arranged between said first substrate and one of said electrodes.

6. Display device according to claim 1, wherein a reflector element is arranged on one of said substrates, being a back substrate, in the area between said electrodes as seen from a viewer side of said display device.

7. Display device according to claim 6, wherein said back substrate is transmissive and said reflector is one of a semi-transmissive reflector or a patterned reflector, in order to allow transflective operation.

8. Display device according to claim 7, wherein the patterned reflector is such that the pixel comprises a reflector area and a transmission area, each essentially extending between said first and second electrode.

9. Display device according to claim 7, wherein the patterned reflector is such that the pixel comprises a reflector area and a transmission area, each being essentially parallel with said first and second electrode.

10. Display device according to claim 1, wherein said layer of electrophoretic material consists of a suspension of one of absorbing or reflecting particles in a liquid.

11. Display device according to claim 1, wherein said layer of electrophoretic material comprises two or more domains, containing particles having mutually different absorption spectra.

12. Display device according to claim 1, said layer of electrophoretic material comprises at least one domain comprising two or more types of particles having mutually different absorption spectra.
